(19) United States
(12) Patent Application Publication
(10) Pub. No.: US 2010/0161671 A1
(43) Pub. Date: Jun. 24, 2010

(54) System and method for generating hierarchical categories from collection of related terms

(76) Inventor: Vladimir Charnine, Windsor (CA)

Correspondence Address: VLADIMIR CHARNINE, 539 ELLIS ST. W, WINDSOR, ON, N8X 1B3, CA

(21) Appl. No.: 12/636,622

(22) Filed: Dec. 11, 2009

Related U.S. Application Data
(60) Provisional application No. 61/096,255, filed on Dec. 22, 2008.

(51) Int. Cl. G06F 17/30

(52) U.S. Cl. 707/797; 707/E17.012

(57) ABSTRACT

An apparatus, system, and method are disclosed for generating hierarchical categories from collection of related terms. The collection of terms and their interrelationships is accumulated and stored in a database module together with a communication history. An input/output (I/O) module communicates the interrelationships to a plurality of users. The users select and possibly rank hierarchical (parent-child) interrelationships. The I/O module receives selected interrelationships from the users. An integration module creates weighted directed graphs of terms and selected interrelationships according to an integration policy. A cycle-breaking module breaks any cycles in the graphs. A selection module creates a hierarchical structure by selecting one primary parent node (parent category) for each node (term) in the graphs.

### CROSS-REFERENCE TO RELATED APPLICATIONS

This application claims benefit of U.S. Provisional Patent Application No. 61/096,255, filed Dec. 22, 2008, which is incorporated herein by reference.

### BACKGROUND OF THE INVENTION

1. Field of the Invention

This invention relates generally to information management and organization. More particularly, the invention relates to generating hierarchical category structure from collection of terms and their relationships.

2. Description of the Related Art

Hierarchical category structures are important for organizing and presenting search results, large sets of documents, topic terms, concepts, objects and products.

Popular web directories such as YAHOO, GOOGLE and DMOZ have shown that a hierarchical category structure is very useful for browsing large stores of information.

A hierarchy of categories is a tree-like structure in which each category (node) is attached to one or more subcategories (nodes) directly beneath it. The connections between categories (nodes) are called branches or links. Category trees are often called inverted trees because they are normally drawn with the root at the top.

Each node in a category tree is addressable according to its path from the root that is often called “full category name”. A path in a tree is a sequence of nodes such that each node, except the last node in the sequence, is followed by one of its children. For example, the full category name “Business/Customer Service/Software” represents the path which contains nodes “Business”, “Customer Service” and “Software”.

Generally, node names are not unique in a category tree. For example, current DMOZ category tree has many different nodes with the name “Software”: “Computers/Software”, “Business/Customer Service/Software” and “Reference/Knowledge Management/Software”.

There is a need for a method that generates more meaningful categories where each node has a unique name in the category tree, and the meaning of the node name is equal or similar to the meaning of the full category name. For example, the above mentioned categories can be presented as: “Computers/Software”, “Business/Customer Service/Customer Service Software” and “Reference/Knowledge Management/Knowledge Management Software”. In this case each node can be addressable both by its unique node name and by its path from the root. The path for the node contains additional related terms (keywords) that can give some key ideas about the category and help to understand the meaning of the node name.

Category tree structure uses traditional direct parent-child relationship, where each child category has a single parent category. In a more complicated model, the category hierarchy takes the form of a directed acyclic graph (DAG), where child category can have multiple parent categories. This data structure is described as a “polyhierarchy” since it may result in singular category involved in more than one direct relationship with more general category (multiple parents).

A node with multiple parents has more than one path in a polyhierarchy. For example, if node “Knowledge Management Software” have two parents “Software” and “Knowledge Management”, then this node can have two different paths: “Computers/Software/Knowledge Management Software” and “Reference/Knowledge Management/Knowledge Management Software”.

When a category (node) in polyhierarchy have multiple paths it is often difficult to select one primary path which gives more key ideas and better describes the meaning of the category. So, there is a need for a method that selects one primary path for each node in a polyhierarchy of categories.

Numerous automated methods have been developed for generating hierarchical categories. Most of these methods use extracting descriptive terms from the corpus of documents.

Some of these methods use lexical information to extract terms and to arrange them in hierarchical order.

“Clustering” and “machine learning” techniques are often employed to categorize related documents based on the terms in each document.

Other methods use “word counting” or “data mining” techniques to discovering relationships between terms, group similar documents and generate hierarchy.

Another methods use statistical analysis and conditional probabilities of co-occurrence of terms in the corpus of documents to find related term pairs. These related terms then can be clustered to arrange them in a hierarchy.

As a preliminary step all these automated methods generate collection of related terms or term pairs that can be gathered and used for hierarchy generation by the method of current invention.

The above automated methods usually generate hierarchy that is not satisfactory for human being recognition. The categories generated by such automated methods either tend not to be very meaningful or in some cases to be very confusing.

Human-edited hierarchical category structure presents strong semantic features, but this generation process is both labor-intensive and inconsistent under large scale hierarchy.

Therefore, what is needed is a method for organizing terms and term pairs gathered from diverse sources, such as different people, agents or automatic programs.

What is needed then, is a method for organizing term pairs into human-readable, semantic-oriented hierarchy of categories.

That is, what is needed is a method for organizing related terms into keywen hierarchy of categories which is polyhierarchy with one primary tree comprising all nodes of the polyhierarchy.

### SUMMARY OF THE INVENTION

From the foregoing discussion, there is a need for an apparatus, system, and method that generate hierarchical categories. Beneficially, such an apparatus, system, and method would improve quality, dynamism, and flexibility of hierarchical category structure.

The present invention has been developed in response to the present state of the art, and in particular, in response to the problems and needs in the art that have not yet been fully solved by currently available methods for generating hierarchical categories from collection of related terms. Accordingly, the present invention has been developed to provide an apparatus, system, and method for generating hierarchical categories from collection of related terms that overcome many or all of the above-discussed shortcomings in the art.

The apparatus for generating hierarchical categories is provided with a plurality of modules configured to functionally execute the steps of: storing interrelationships between terms and communication history; communicating the interrelationships to a plurality of users, receiving selected hierarchical interrelationships from the users; creating weighted directed graphs of terms and selected interrelationships; breaking any cycles in the graphs; and selecting one primary parent node (parent category) for each node (term) in the graphs. These modules in the described embodiments include a database module, an input/output (I/O) module, an integration module, a cycle-breaking module, and a selection module. The apparatus may also include a category ranking module.

The database module stores interrelationships between terms and communication history. The I/O module communicates the interrelationships to a plurality of users. In addition, the I/O module receives selected hierarchical interrelationships from the users.

The integration module creates weighted directed graphs of terms and selected interrelationships according to an integration policy. The cycle-breaking module breaks any cycles in the graphs. The selection module creates a hierarchical structure from the graphs by selecting one primary parent node (parent category) for each node (term) in the graphs. In one embodiment, the category ranking module creates rank of terms by using data from the weighted directed graphs. The cycle-breaking module breaks cycles by reversing edges from lower ranked terms to higher ranked terms. The apparatus generates hierarchical categories from collection of related terms.

A system of the present invention is also presented to generate hierarchical categories. The system may be embodied in an information technology system that generates hierarchical categories from collection of related terms. In particular, the system, in one embodiment, includes a memory module and a processor module.

The memory module stores software instructions and data. The processor module executes the instructions and processes the data. The processor module includes a database module, an I/O module, integration module, a cycle-breaking module, and a selection module. The processor module may also include a category ranking module.

The database module stores interrelationships between terms and communication history. The I/O module communicates the interrelationships to a plurality of users. In addition, the I/O module receives selected hierarchical interrelationships from the users. The integration module creates weighted directed graphs of terms and selected interrelationships according to an integration policy. The category ranking module may create rank of terms by using data from the weighted directed graphs. The cycle-breaking module breaks any cycles in the graphs. The selection module creates a hierarchical structure from the graphs by selecting one primary parent node (parent category) for each node (term) in the graphs. The system generates hierarchical categories from collection of related terms.

A method of the present invention is also presented for generating hierarchical categories from collection of related terms. The method in the disclosed embodiments substantially includes the steps to carry out the functions presented above with respect to the operation of the described apparatus and system. In one embodiment, the method includes storing interrelationships between terms and communication history, communicating the interrelationships to a plurality of users, receiving selected hierarchical interrelationships from the users, creating weighted directed graphs of terms and selected interrelationships, breaking any cycles in the graphs, and selecting one primary parent node (parent category) for each node (term) in the graphs. The method also may include ranking of category terms by using data from weighted directed graphs.

The database module stores interrelationships between terms and communication history. The I/O module communicates the interrelationships to a plurality of users. In addition, the I/O module receives selected hierarchical interrelationships from the users. The integration module creates weighted directed graphs of terms and selected interrelationships according to an integration policy. The category ranking module may create rank of terms by using data from the weighted directed graphs. The cycle-breaking module breaks any cycles in the graphs. The selection module creates a hierarchical structure from the graphs by selecting one primary parent node (parent category) for each node (term) in the graphs. The method generates hierarchical categories from collection of related terms.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention generates hierarchical categories from collection of related terms. In addition, the present invention may increase quality, dynamism, and flexibility of hierarchical category structure. These features and advantages of the present invention will become more fully apparent from the following description and appended claims, or may be learned by the practice of the invention as set forth hereinafter.

### DEFINITIONS

Hierarchy is a form of organizational structure in which each node has one and only one “parent” node, except the “top” or “root” node, which has none.

Polyhierarchy is a directed acyclic graph or a partially ordered set. A Polyhierarchy (or multi-hierarchy) is like a hierarchy, but nodes can have multiple parents.

Keywen structure (keywen hierarchy) is a polyhierarchy which comprises one preferred tree that comprises all nodes of the polyhierarchy. Keywen structure was first described in the book “Keywen Category Structure”.

Directed graphs—applies to any graph problem where there are nodes and information for each node indicating other reachable nodes. The term “directed graph” as used herein is generic to any data set which defines such a problem.

Database is a directed graph wherein the data is in tabular form and wherein the records thereof include information interrelating the records.

Nodes, records or elements—as used herein these are synonymous terms and include reachability information to other nodes, records or elements.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a computer in accordance with the present invention;

FIG. 2 is a schematic block diagram illustrating one embodiment of a hierarchy generation module of the present invention.

FIG. 3 is a diagram illustrating the interrelationships between five related terms according to the invention.

FIG. 4 is a diagram illustrating selected interrelationships between five related terms according to the invention.

FIG. 5 is a diagram illustrating one embodiment of weighted directed graph comprising five related terms according to the invention.

FIG. 6 is a diagram illustrating one embodiment of weighted acyclic directed graph comprising five related terms according to the invention.

FIG. 7 is a diagram illustrating one embodiment of generated hierarchical category structure comprising five related terms according to the invention.

FIG. 8 is a schematic flow chart diagram illustrating one embodiment of a hierarchy generation method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGA), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within the modules, and may be embodied in any suitable form and organized within any suitable type of data structure. The operational data may be collected as a single data set, or may be distributed over different locations including different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention.

One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

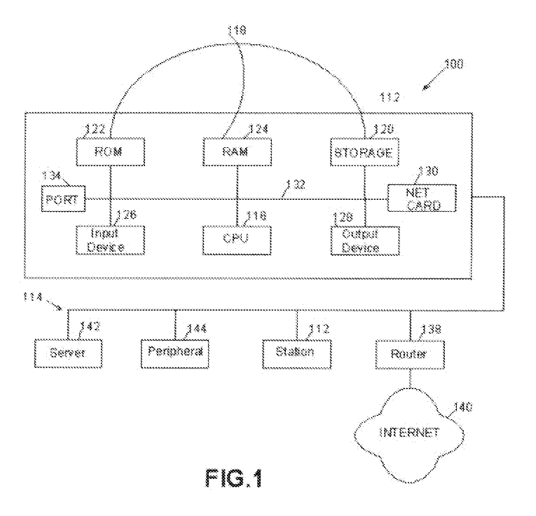

FIG. 1 depicts a schematic block diagram illustrating one embodiment of a computer system 100 suitable for employing the apparatus, system, and method of the present invention.

In FIG. 1, one or more computer stations 112 may be hosted on a network 114. Typical networks 114 generally comprise wide area networks (WANs), local networks (LANs) or interconnected systems of networks, one particular example of which is the Internet and the World Wide Web supported on the Internet.

A typical computer station 112 may include a processor module or CPU 116. The CPU 116 may be operably connected to one or more memory devices 118. The memory devices 118 are depicted as including a non-volatile storage device 120 such as a hard disk drive or CD-ROM drive, a read-only memory (ROM) 122, and a random access volatile memory (RAM) 124.

The computer station 112 of system 110 in general may also include one or more input devices 126, such as a mouse or keyboard, for receiving inputs from a user or from another device. Similarly, one or more output devices 128, such as a monitor or printer, may be provided within or be accessible from the computer system 100. A network port such as a network interface card 130 may be provided for connecting to outside devices through the network 14. In the case where the network 114 is remote from the computer station, the network interface card 130 may comprise a modem, and may connect to the network 114 through a local access line such as a telephone line.

Within any given station 112, a system bus 132 may operably interconnect the CPU 116, the memory devices 118, the input devices 126, the output devices 128, the network card 130, and one or more additional ports 134. The system bus 132 and a network backbone 136 may be regarded as data carriers. As such, the system bus 132 and the network backbone 136 may be embodied in numerous configurations. For instance, wire, fiber optic line, wireless electromagnetic communications by visible light, infrared, and ratio frequencies may be implemented as appropriate.

In general, the network 114 may comprise a single local area network (LAN), a wide area network (WAN), several adjoining networks, an intranet, or as in the manner depicted, a system of interconnected networks such as the Internet 140. The individual stations 112 communicate with each other over the backbone 136 and/or over the Internet 140 with varying degrees and types of communication capabilities and logic capability. The individual stations 112 may include a mainframe computer on which the modules of the present invention may be hosted.

Different communication protocols, e.g., ISO/OSI, IPX, TCP/IP, may be used on the network. In the case of the Internet, a single, layered communications protocol (TCP/IP) generally enables communication between the differing networks 114 and stations 112. Thus, a communication link may exist, in general, between any of the stations 112.

In addition to the stations 112, other devices may be connected on the network 114. These devices may include application servers 142, and other resources or peripherals 144, such as printers and scanners. Other networks may be in communication with the network 114 through a router 138 and/or over the Internet.

The memory devices 118 store software instructions and data. The processor module 16 executes one or more computer program products. The computer program products may be tangibly stored in the storage module 120 or ROM 122.

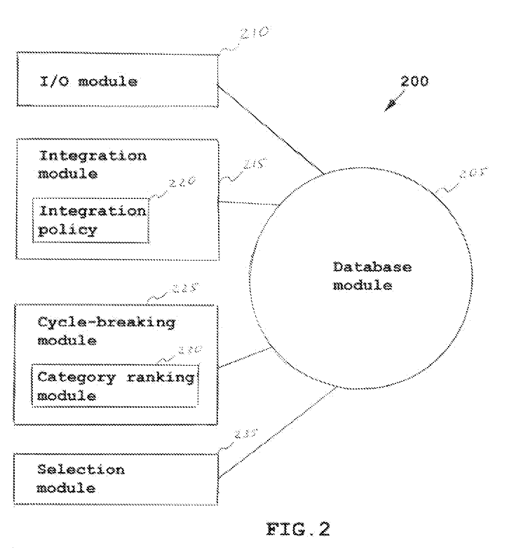

FIG. 2 depicts a schematic block diagram illustrating one embodiment of a hierarchy generation apparatus 200 of the present invention. The apparatus 200 generates hierarchical categories and can be embodied in the computer system 100 of FIG. 1. The description of apparatus 200 refers to elements of FIG. 1, like numbers referring to like elements. The apparatus 200 includes a database module 205, an I/O module 210, an integration module 215, an integration policy 220, a cycle-breaking module 225, a category ranking module 230, and a selection module 235. The database module 205, I/O module 210, integration module 215, integration policy 220, cycle-breaking module 225, category ranking module 230, and selection module 235 may comprise one or more computer program products executing on the computer 100.

The database module 205 stores interrelationships between terms and communication history.

The I/O module 210 communicates the interrelationships to a plurality of users.

The I/O module 210 receives selected hierarchical interrelationships from the users.

The integration module creates 215 weighted directed graphs of terms and selected interrelationships according to an integration policy 220.

In one embodiment, the integration policy 220 comprises contribution shares of users that can be set up manually or automatically. The weight of each edge (interrelationship) is calculated as a sum of contribution shares of users that select this interrelationship.

The cycle-breaking module 225 breaks any cycles in the graphs. For example, it can be realized as described in U.S. Pat. No. 4,953,106.

In one embodiment, the category ranking module 230 creates rank of terms by using data from the weighted directed graphs. The cycle-breaking module 225 first breaks cycles by reversing edges from lower ranked terms to higher ranked terms and second breaks any other cycles in the graphs.

The selection module 235 creates a hierarchical structure from the graphs by selecting one primary parent node (parent category) for each node (term) in the graphs. The apparatus 200 generates hierarchical categories from collection of related terms.

FIG. 3 depicts a diagram illustrating the interrelationships between five related terms according to the invention.

A collection of related terms can be represented as undirected graph of N nodes, where each node corresponds to a term and where the undirected connections between nodes correspond to interrelationships between terms.

FIG. 3 shows possible interrelationships between five related terms A, B, C, D, and E. As shown in this particular figure, the term A has interrelationships with terms B and E, Term B has interrelationships with A, C, and D; term C has interrelationships with B, and D; term D has interrelationships with B, C, and E; term E has interrelationships with A, and D. Terms A, B, C, D, and E may have other interrelationships with terms that are not shown.

FIG. 4 depicts a diagram illustrating selected interrelationships between five related terms according to the invention.

A set of selected interrelationships between terms is a result of communication with users.

The I/O module 210 communicates the interrelationships from database to a plurality of users.
The users select and possibly rank hierarchical (parent-child) interrelationships.
The users also select the direction of interrelationships.
The I/O module 210 receives selected and ranked hierarchical interrelationships from the users.

A set of selected interrelationships between terms can be represented as a directed graph of N nodes, where each node corresponds to a term and where each directed connection between two nodes corresponds to directed parent-child interrelationship between two terms made by a user. FIG. 4 shows possible selected interrelationships between five related terms A, B, C, D, and E.

As shown in this particular figure, the user U1 selects A as parent for E, selects B as parent for A, and selects C as parent for B. In addition, the user U2 selects B as parent for A, selects C and D as parents for B, and selects E as parent for D. Also the user U3 selects C as parent for D.

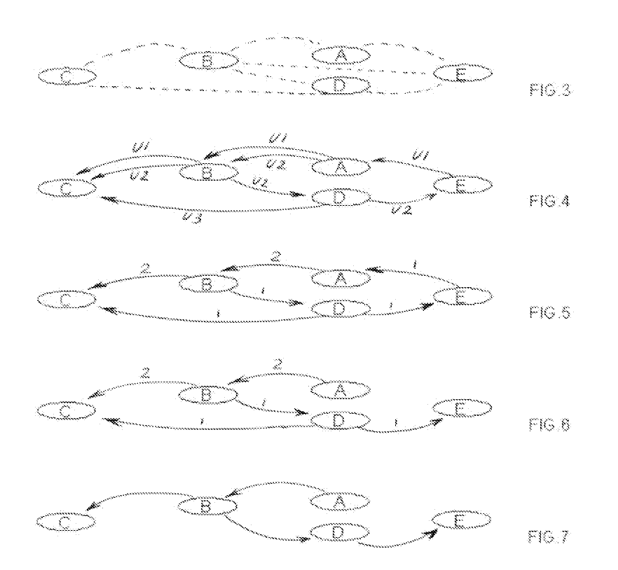

FIG. 5 depicts a diagram illustrating one embodiment of weighted directed graph comprising five related terms according to the invention.

A set of weighted interrelationships between terms can be represented as a weighted directed graph of N nodes, where each node corresponds to a term and where the weighted directed connections between nodes (edges) correspond to weighted directed interrelationships between terms.

FIG. 5 shows possible weighted interrelationships between five related terms A, B, C, D, and E. As shown in this particular figure, the edge AB has weight 2, the edge BC has weight 2, the edge BD has weight 1, the edge DC has weight 1, the edge DE has weight 1, and the edge EA has weight 1.

A set of weighted interrelationships between related terms forms weighted directed graphs.

The integration module creates weighted directed graphs of terms and selected interrelationships according to an integration policy.

In one embodiment, the integration policy 220 comprises contribution shares of users that can be set up manually or automatically. The weight of each edge (interrelationship) is calculated as a sum of contribution shares of users that select this interrelationship.

For example, the weighted directed graph shown in FIG. 5 can be created by the integration module 215 from a set of selected interrelationships shown in FIG. 4 if the integration policy 220 comprises contribution shares users, if contribution share of each user (U1, U2, and U3) is equal to 1, and if the integration module 215 comprises a rule to calculate the weight of each edge as a sum of contribution shares of users that select this edge (interrelationship).

FIG. 6 depicts a diagram illustrating one embodiment of weighted acyclic directed graph comprising five related terms according to the invention.

The weighted directed graph shown in FIG. 6 can be created by the cycle-breaking module 225 from the weighted directed graph shown in FIG. 5. For example, cycle-breaking module 225 can be realized as described in U.S. Pat. No. 4,953,106.

The FIG. 5 shows that directed edges AB, BD, DE, and EA together form a cycle. This cycle can be breaking by deleting the directed edge EA. The graph (FIG. 6) can be created from the graph (FIG. 5) by breaking the cycle and deleting the edge EA. The graph (FIG. 6) contains no cycles so it can be called as weighted acyclic directed graph.

In one embodiment, the category ranking module 230 creates rank of terms by using data from the weighted directed graphs. Category ranking module 230 may be realized as outflow ranking method for weighted directed graphs. The cycle-breaking module first breaks cycles by reversing (or deleting) edges from lower ranked terms to higher ranked terms and second breaks any other cycles in the graphs.

For example, the FIG. 5 shows that directed edges Aft BD, DE, and EA together form a cycle. This cycle can be broken by deleting the edge EA. The edge EA has a minimum weight in the cycle. Also, the edge EA is directed from low ranking node E to node A with greater rank. The rank of nodes can be calculated according to outflow ranking method for weighted directed graphs. According to the outflow ranking method the rank of node A is 2 and the rank of node E is 1.

FIG. 7 depicts a diagram illustrating one embodiment of generated hierarchical category structure comprising five related terms according to the invention.

As shown in this particular figure, the category term A is a root of hierarchy and has no parents, the category term B has one parent A, the category term C has one parent B, the category term D has one parent B, and the category term E has one parent D.

The hierarchical category structure shown in FIG. 7 can be created by the selection module 235 from the weighted directed graph shown in FIG. 6. The selection module 235 creates a hierarchical structure from the weighted directed graphs by selecting 835 one primary parent node (parent category) for each node (term) in the graphs.

For example, the FIG. 6 shows that node C has parents B and D. The directed edge BC has weight 2 and directed edge DC has weight 1. The selection module 235 selects B as preferred parent for C, because the directed edge BC has maximal weight. Also, the selection module 235 deletes the edge DC that has minimal weight. The graph (FIG. 7) can be created from the graph (FIG. 6) by deleting the edge DC.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and the symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

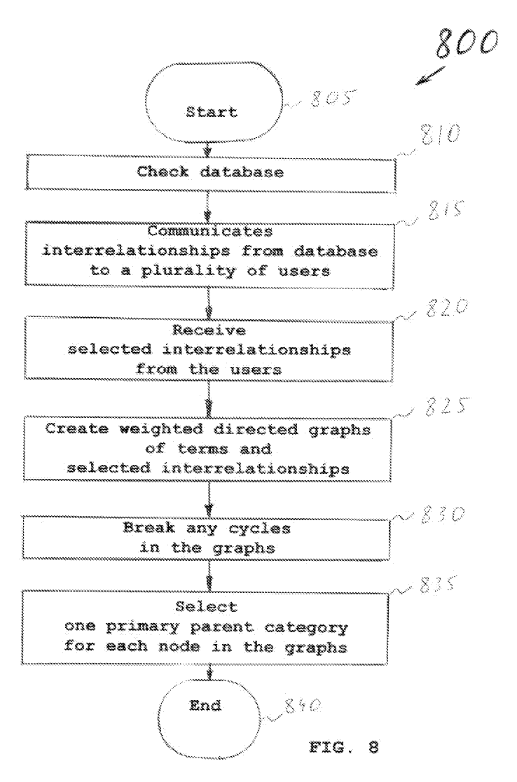

FIG. 8 depicts a schematic flow chart diagram illustrating one embodiment of a hierarchy generation method 800 of the present invention. The method 800 substantially includes the steps to carry out the functions presented above with respect to the operation of the described apparatus 200 and system 100 of FIGS. 2 and 1 respectively. The description of method 800 refers to elements of FIGS. 1-2, like numbers referring to like elements. In one embodiment, the method 800 is implemented with a computer program product comprising a computer readable medium having a computer readable program. The computer 100 may execute the computer readable program.

The method 800 starts 805, and it checks 810 that database 205 is available and stores interrelationships between terms and communication history.

The I/O module 210 communicates 815 the interrelationships from database 205 to a plurality of users. The I/O module 210 may communicate the interrelationships as an email, a post of data to a user server, a post of data to a web site and/or a directory accessible by the users, and the like.

The I/O module 210 receives 820 selected and ranked hierarchical interrelationships from the users. The selection may be communicated as an email from a user, a posting of a one or more data fields to the computer 100, and/or a telephone call to a call center. An attendant may manually enter the selection into a data set of the computer 100. Alternatively, the selection may be automatically received and stored by the computer 100.

The selection may be realized as voting procedure. According to a voting terminology the users can be called as voters. The list of all interrelationships of particular term can be called as questionnaire or ballot. Ranked voting data arise when users (voters) select and rank more than one interrelationship with order of preference. Voters rank interrelationships (candidates) in the order of their preference (1, 2, 3, etc.)—picking and choosing among other interrelationships in the questionnaire.

The integration module 215 creates 825 weighted directed graphs of terms and selected interrelationships according to an integration policy 220.

In one embodiment, the integration policy 220 comprises contribution shares of users that can be set up manually or automatically. The weight of each edge (interrelationship) is calculated as a sum of contribution shares of users that select this interrelationship.

The cycle-breaking module 225 breaks 830 any cycles in the graphs. For example, it can be realized as described in U.S. Pat. No. 4,953,106.

In one embodiment, the cycle-breaking module 225 comprises the category-ranking module 230 that creates rank of category terms by using data from the weighted directed graphs. The cycle-breaking module 225 first breaks cycles by reversing edges from lower ranked terms to higher ranked terms and second breaks any other cycles in the graphs.

The selection module 235 creates a hierarchical structure from the weighted directed graphs by selecting 835 one primary parent node (parent category) for each node (term) in the graphs.

The method 800 automates receiving selections from users and automates generating hierarchical categories from collection of related terms. The method 800 may employ one or more integration policies 220 to improve quality, dynamism, and flexibility of generated hierarchy.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “generating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

The embodiment of the present invention generates hierarchical categories from collection of related terms. In addition, the present invention may improve quality, dynamism, and flexibility of hierarchical category structure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for generating hierarchical categories from collection of related terms, the apparatus comprising: a database module configured to store interrelationships between terms and communication history; an input/output (I/O) module configured to communicate the interrelationships to a plurality of users and receives selected hierarchical interrelationships from the users; an integration module configured to create weighted directed graphs of terms and selected interrelationships according to an integration policy; a cycle-breaking module configured to break any cycles in the weighted directed graphs; and a selection module configured to create a hierarchical structure from the graphs by selecting one primary parent node (parent category) for each node (term) in the graphs.

2. The apparatus of claim 1, wherein the integration policy comprises contribution shares of users, the integration module is further configured to calculate the weight of edge (interrelationship) as weighted sum of the contribution shares of users that select this interrelationship.

3. The apparatus of claim 1, wherein the selecting module is configured to select one primary parent node with maximum weight for each node in the graphs.

4. The apparatus of claim 1, wherein the I/O module is configured to receive only one selected parent-child interrelationship (parent category) for each term from each user.

5. The apparatus of claim 1, wherein the I/O module is configured to allow a user to select and rank hierarchical interrelationships, and the integration module is further configured to increase the weights of interrelationships with higher ranks in the graphs.

6. The apparatus of claim 1, wherein the input/output (I/O) module is configured to receive suggestions from the users about new terms and new hierarchical interrelationships and to update the database.

7. The apparatus of claim 1, wherein the term “users” means people, or organizations, or agents, or automatic programs.

8. The apparatus of claim 1, wherein the selection module is configured to build a Keywen structure that is a polyhierarchy which comprises one preferred tree that comprises all nodes of the polyhierarchy.

9. A computer program product comprising a computer useable medium having a computer readable program, wherein the computer readable program when executed on a computer causes the computer to: accumulate and store interrelationships between terms and communication history; communicate the interrelationships to a plurality of users that are selecting and possibly ranking hierarchical (parent-child) interrelationships; receive selected interrelationships from the users; create weighted directed graphs of terms and selected interrelationships according to an integration policy; break any cycles in the weighted directed graphs; and create a hierarchical structure from the graphs by selecting one primary parent node (parent category) for each node (term) in the graphs.

10. A system for generating hierarchical categories from collection of related terms, the system comprising: a memory module configured to store software instructions and data; a processor module configured to execute the software instructions and process the data and comprising: a database module configured to store interrelationships between terms and communication history; an input/output (I/O) module configured to communicate the interrelationships to a plurality of users and receives selected hierarchical interrelationships from the users; an integration module configured to create weighted directed graphs of terms and selected interrelationships according to an integration policy; a cycle-breaking module configured to break any cycles in the weighted directed graphs; and a selection module configured to create a hierarchical structure from the graphs by selecting one primary parent node (parent category) for each node (term) in the graphs.

11. A method for deploying computer infrastructure, comprising integrating computer readable code into a computing system, wherein the code in combination with the computing system is capable of performing the following: storing interrelationships between terms and communication history; communicating the interrelationships to a plurality of users, receiving selected hierarchical interrelationships from the users; creating weighted directed graphs of terms and selected interrelationships; breaking any cycles in the weighted directed graphs; and selecting one primary parent node (parent category) for each node (term) in the graphs.
